(19) United States
(12) Patent Application Publication
(10) Pub. No.: US 2013/0200604 A1
(43) Pub. Date: Aug. 8, 2013

(54) TANK FOR A UTILITY TERRAIN VEHICLE

(71) Applicants: James Bergman, Oslo, MN (US); Larry Holter, Alvarado, MN (US); Rick Nelson, Oslo, MN (US); Dave Paschke, East Grand Forks, MN (US)

(72) Inventors: James Bergman, Oslo, MN (US); Larry Holter, Alvarado, MN (US); Rick Nelson, Oslo, MN (US); Dave Paschke, East Grand Forks, MN (US)

(73) Assignee: BEAMCO, INC., Oslo, MN (US)

(21) Appl. No.: 13/570,842

(22) Filed: Aug. 9, 2012

Related U.S. Application Data
(60) Provisional application No. 61/521,443, filed on Aug. 9, 2011.

(51) Int. Cl. B62D 21/16

(52) U.S. Cl. CPC B62D 21/16
USPC 280/783

(57) ABSTRACT

A first embodiment includes a utility terrain vehicle having four or more wheels, a frame held above the ground by the wheels, and a liquid storage tank. The liquid storage tank is attached to the frame to create a low center of gravity for the utility terrain vehicle.

### CROSS-REFERENCE TO RELATED APPLICATION(S)

This application claims priority to U.S. Provisional Application No. 61/521,443, filed on Aug. 9, 2011, and entitled “Tank for an all terrain vehicle,” the disclosure of which is incorporated by reference in its entirety.

### BACKGROUND

The present application relates to personal off-road vehicles. More particularly, the application discloses a small off-road vehicle, commonly referred to as a utility terrain vehicle, with improvements geared towards applications for military, law enforcement, and emergency personnel.

Over the last several years, the popularity of utility terrain vehicles (also referred to as “UTVs”) has greatly increased. UTVs are practical and versatile, as the vehicle may be used for work or leisure related tasks. The compact nature, mobility, and traction of UTVs means the vehicles are capable of traversing all sorts of surfaces, from the relatively smooth surfaces of paved roadways to rough, uneven terrains, including rocky areas, woodland trails, wetlands, and sand dunes. UTVs are also typically designed to pull or push various objects such as a trailer or a snow-plow.

A typical UTV is a personal vehicle and may contain side by side seats. Such a vehicle comprises four or more wheels mounted to a frame, the front wheels being steerable. A fuel tank and a seat are disposed on an upper portion of the frame. The engine, which represents one of the heaviest components of the vehicle, is typically mounted in a central portion of the vehicle. The engine location is specifically chosen to ensure a proper weight distribution. If the engine is water cooled, a radiator will be provided in front of the engine. The fuel tank is adjacent the engine.

While such a configuration provides vehicles with performance levels that are more than adequate, there are nonetheless many disadvantages associated with it. For example, if the vehicle is to be used for special utility purposes, or by emergency personnel or military personnel, additional vehicle storage, stability, and utility are required from what is typically found in a standard model known in the art. Particularly, absent in the prior art is a system with a large liquid holding tank.

### SUMMARY

A first embodiment includes a utility terrain vehicle having four or more wheels, a frame held above the ground by the wheels, and a liquid storage tank. The liquid storage tank is attached to the frame to create a low center of gravity for the utility terrain vehicle.

A second embodiment includes a utility terrain vehicle having two front tires and two rear tires, a vehicle frame held above the ground by the front tires and the rear tires, one or more seats, and a liquid storage tank. The seats have a seat frame, a lower seating surface, and an upper seating surface. The liquid storage tank is located above the vehicle frame and below the seat frame.

A third embodiment includes a utility terrain vehicle having two front tires and two rear tires, a vehicle frame held above the ground by the front tires and the rear tires, a subframe attached to the vehicle frame to provide additional support to the vehicle, a first seat and a second seat, a flatbed, a pump carried on the flatbed, a liquid storage tank, and an inlet to the liquid storage tank. The first and second seats have a combined seat frame, a lower seating surface, and an upper seating surface. The liquid storage tank is located above the vehicle frame and below the lower seating surface.

### BRIEF DESCRIPTION OF THE DRAWINGS

FIG. 1 is a side elevation view of a tank for a utility terrain vehicle (UTV).

FIG. 2 is a perspective view of the tank from the passenger's side of the vehicle.

FIG. 3 is a perspective view of the tank from the driver's side of the vehicle.

FIG. 4 is a side elevation view of the tank.

FIG. 5 is a rear perspective view of the tank from the driver's side of the vehicle.

FIG. 6 is perspective view of a multi-passenger UTV with a specialized tank.

FIG. 7 is a perspective view of a tank beneath the seats of an UTV.

FIG. 8 is a rear perspective view of the tank from the driver's side of the vehicle with a portion of the seat removed.

FIG. 9 is a front perspective view of the tank from the driver's side of the vehicle with the seat removed.

FIG. 10 is front elevation view of the tank for the vehicle with a portion of the seat removed.

FIG. 11 is a front perspective view of the tank from the passenger's side of the vehicle with the seat removed.

FIG. 12 is a passenger side elevation view of a multi-passenger UTV.

FIG. 13 is a passenger side elevation view of the fuel tank for an UTV.

FIG. 14 is a side elevation view of the UTV tank.

FIG. 15 is a top plan view of a UTV tank beneath seating for the vehicle.

FIG. 16 is a passenger's side perspective view of the UTV tank beneath seating for the vehicle.

FIG. 17 is a driver's side perspective view of the UTV tank beneath seating for the vehicle.

FIG. 18 is a perspective view of the tank and rear passenger seating area.

FIG. 19 is a top plan view of the tank.

FIG. 20 is a side plan view of the tank.

FIG. 21 is a perspective view of the tank.

FIG. 22 is a front elevation view of the tank.

### DETAILED DESCRIPTION

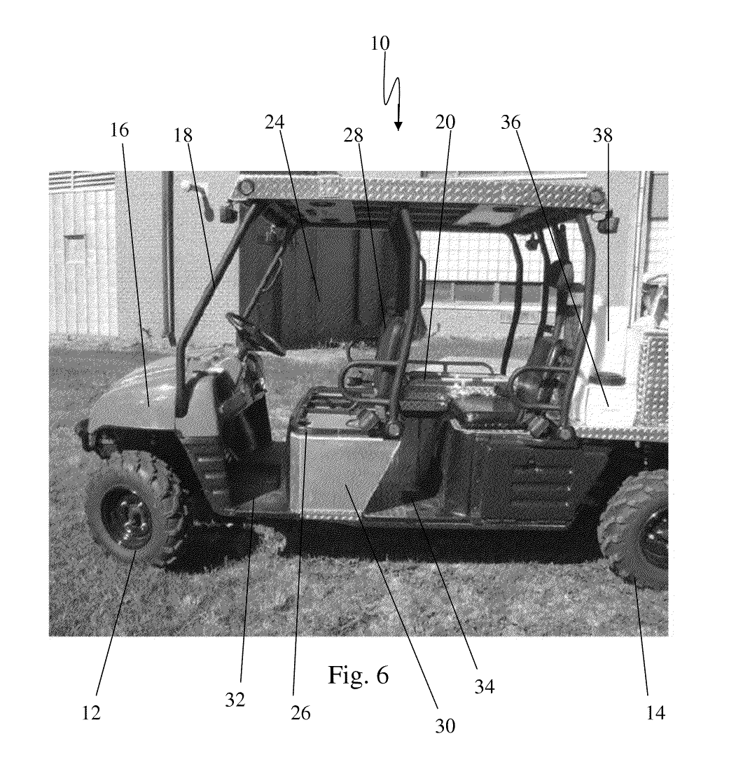

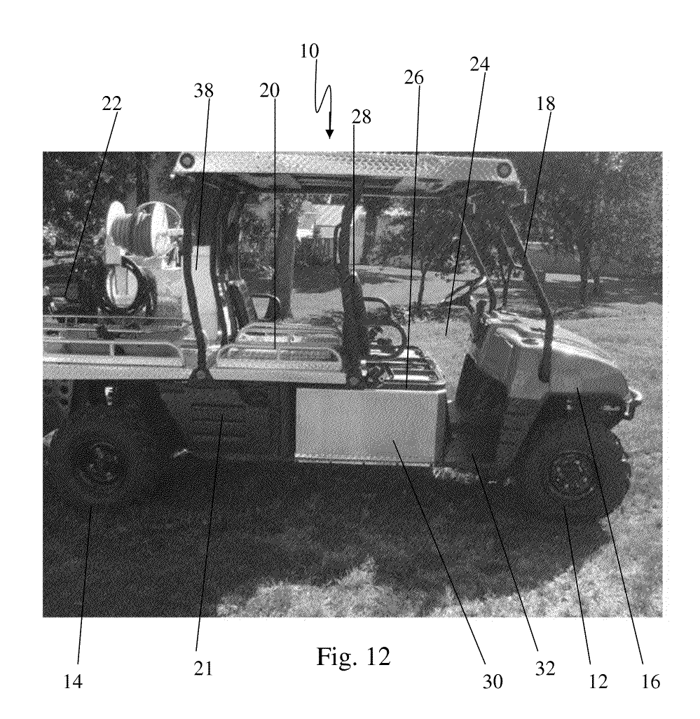

FIG. 6 is a perspective view of multi-passenger UTV 10 with liquid tank 30. FIG. 12 is a passenger side elevation view of multi-passenger UTV 10. UTV 10 includes front wheels 12, rear wheels 14, main body portion 16, cage 18, flatbed 20, gas tank 21, pump 22, cab 24, seat frame 26, upper seat 28, lower seat 29 (not shown), liquid tank 30, front footrest 32, rear footrest 34, liquid tank inlet 36, flatbed tank 38, a frame, and a subframe. Front wheels 12 are capable of being steered and front wheels 12 and rear wheels 14 are attached to a front axle and rear axle, respectively (not shown). Front wheels 12 and rear wheels 14 are part of a drive train system. Each axle is mounted on a suspension system relative to a frame. The frame supports the drive train system and an engine, where the engine actuates the drive train system. Main body portion 16 covers the frame. The frame is reinforced with a subframe to support the additional weight added to UTV 10 from liquid tank 30.

Other elements of UTV 10 include various support structures, such as flatbed 20 and cage 18. Cage 18 is connected to main body portion 16 and assists in preventing injury to passengers from passing branches or similar obstacles, as well as acting as a support in the event of a vehicle rollover. Cab 24 is defined by main body portion 16 and cage 18. Flatbed 20 extends rearward of cab 24. Flatbed 20 supports pump 22, flatbed tank 38, and liquid tank inlet 36. Pump 22 and liquid tank inlet 36 are connected to tank 30 with hoses. Liquid tank inlet 36 has the capacity to retain some liquid and is thus capable of acting as a surge when filing liquid tank 30. Liquid tank inlet 36 creates a pressure differential between liquid tank 30 and liquid tank inlet 36 so that the liquid in liquid tank inlet 36 moves through the hose into liquid tank 30. UTV 10 also includes gas tank 21 located rearward of liquid tank 30 on the passenger's side, to supply gas to the engine. UTV 10 further includes seat frame 26, upper seat 28, and lower seat 29. Seat frame 26 is disposed on specialized tank 30, and upper seat 28 and lower seat 29 are attached to seat frame 26. Upper seat 28 provides support for the backs of the driver and passengers and lower seat 29 provides support for the sitting of the driver and passengers.

In the embodiment shown, UTV 10 includes three seats: a driver's seat, a first passenger's seat next to the driver's seat, and a second passenger's seat rearward of the driver's seat. A portion of flatbed 20 extends behind the first passenger's seat and next to the second passenger's seat. In other embodiments, UTV 10 may include more seats or fewer seats. Front footrest 32 is forward of liquid tank 30 and provides a place for the driver and first passenger to rest their feet. Rear footrest 34 is located rearward of liquid tank 30 behind the driver's seat and provides a place for the second passenger to rest their feet.

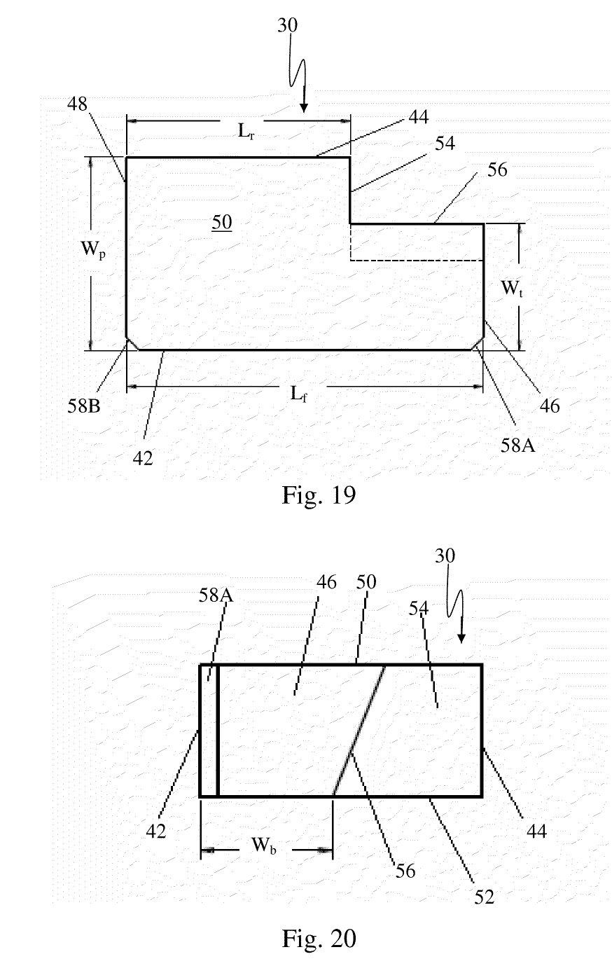

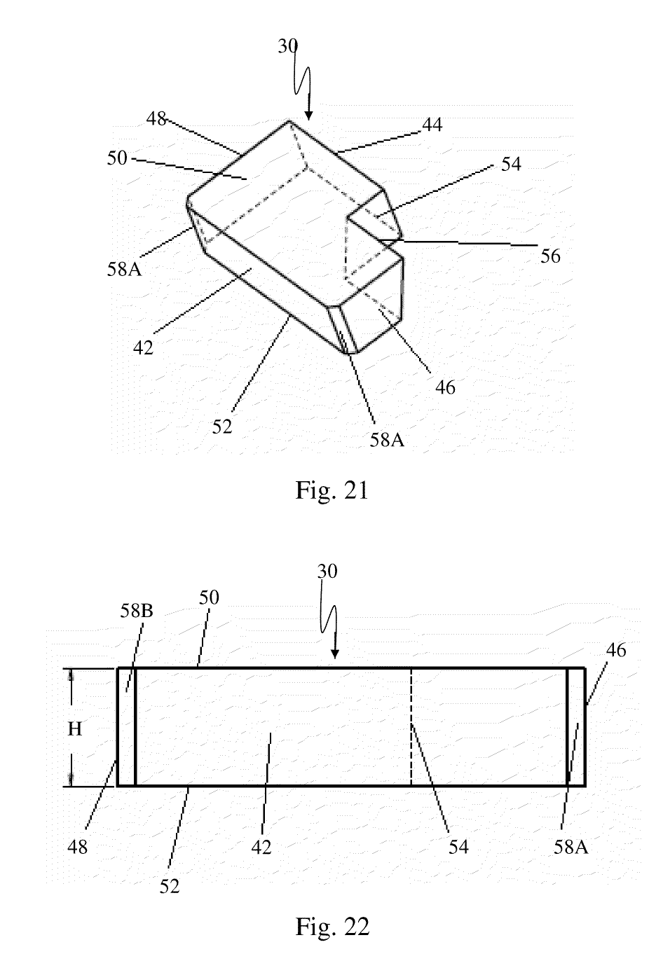

FIG. 21 is a perspective view of liquid tank 30. FIG. 19 is a top plan view of liquid tank 30. FIG. 22 is a front elevation view of liquid tank 30. FIG. 20 is a side plan view of liquid tank 30. Tank 30 includes forward end 42, aft end 44, first side 46, second side 48, third side 54, top side 50, bottom side 52, slanted aft end 56, and curved edges 58A and 58B. Forward end 42 is connected to top side 50, bottom side 52, and curved edges 58A and 58B. Second side 48 is connected to curved edge 58B, top side 50, aft end 44, and bottom side 52. Aft end 44 is connected to top side 50, second side 48, bottom side 52, and third side 54. Second side 46 is connected to top side 50, curved edge 58A, slanted aft end 56, and bottom side 52. Third side 54 is connected to aft end 44, top side 50, bottom side 52, and slanted aft end 56. Slanted aft end 56 is connected to top side 50, bottom side 52, first side 46, and third side 54. Top side 50 is connected to forward end 42, curved edges 58A and 58B, second side 48, aft end 44, third side 54, slanted side 56, and first side 46. Bottom side 52 is connected to forward end 42, curved edges 58A and 58B, second side 48, aft end 44, third side 54, slanted side 56, and first side 46.

In the embodiment shown, tank 30 has the following dimensions: height H of tank 30 is 15 inches; width Wₚ of tank 30 on the first passenger's side is 32 inches; width W_{b} of tank 30 on the driver's side bottom is 15 inches; width Wₜ of tank 30 on the driver's side top is 21 inches; forward length L_{f} of tank 30 is 59 inches; and rear length Lᵣ of tank 30 behind the passenger's seat is 37 inches. The dimensions of tank 30 can be adjusted based on the size and arrangement of UTV 10. For instance, in the case that UTV 10 does not have a second passenger's seat, tank 30 is capable of being shaped to fill the space that is left open for footrest 34 in the embodiment shown.

Tank 30 extends under the driver's seat and passenger's seat, and rearward of the passenger's seat under a portion of flatbed 20. The space behind the driver's seat is left open for rear footrest 34. This allows the second passenger to have leg room when they are riding on UTV 10. The second passenger's leg room is further expanded with slanted aft end 56. Slanted aft end 56 allows tank 30 to extend fully rearward under the driver's seat, while at the same time providing more open space for rear footrest 34. Top side 50 of tank 30 needs to extend fully rearward under the driver's seat to support seat frame 26.

Tank 30 is shaped to be placed under seat frame 26 on UTV 10. Tank 30 is capable of supporting the weight of seat frame 26, upper seat 28, lower seat 29, a portion of flatbed 20, and the sitting weight of an operator and passenger. In the embodiment shown, tank 30 is made out of aluminum, although any material capable of supporting the weight and holding liquid can be used. The materials best suited for supporting the additional weight are rigid materials with a high tensile strength, and the materials best suited for holding liquid are rigid and non-corrosive materials. Tank 30 has the capacity to hold over 100 gallons of liquid.

Tank 30 as designed and as located on UTV 10 provides many benefits, especially when UTV 10 is being used for military, emergency, medical, and fire protection purposes. In the prior art, liquid storage tanks are carried on flatbeds of a UTV. Carrying a liquid storage tank on a flatbed greatly raises the center of gravity of the UTV, which decreased the handling of the vehicles and increased the possibility of a roll-over. Placing tank 30 under seat frame 26 gives UTV 10 a low center of gravity, which improves the handling of UTV 10. When tank 30 is empty, the center of gravity of UTV 10 is similar to the center of gravity of UTV 10 without tank 30. When tank 30 is full, the center of gravity is still lower than the height of the tank and thus low on the vehicle, which reduces the risk of a roll-over. Placing tank 30 under seat frame 26 also distributes the weight of the liquid more evenly across front tires 12 and rear tires 14, which again results in improved handling.

Placing tank 30 under seat frame 26 allows for additional equipment to be carried on flatbed 20 of UTV 10. Opening up this space increases the effectiveness of UTV 10 as a vehicle that can be used in fire fighting. Tank 30 allows for a larger amount of water to be carried on UTV 10 and leaves flatbed 20 open to carry a pump, hose, and other firefighting tools. Opening up flatbed 20 also increases the effectiveness of using UTV 10 for emergency purposes. Flatbed 20 is capable of holding a stretcher and other medical equipment. The configuration of UTV 10 also allows a paramedic to tend to a patient while UTV 10 is moving. Tank 30 is also capable of holding additional fuel for UTV 10, which greatly increases the travel distance of UTV 10. UTV 10 can also hold fire suppressant materials, chemical mixtures for pest control, and any other liquid.

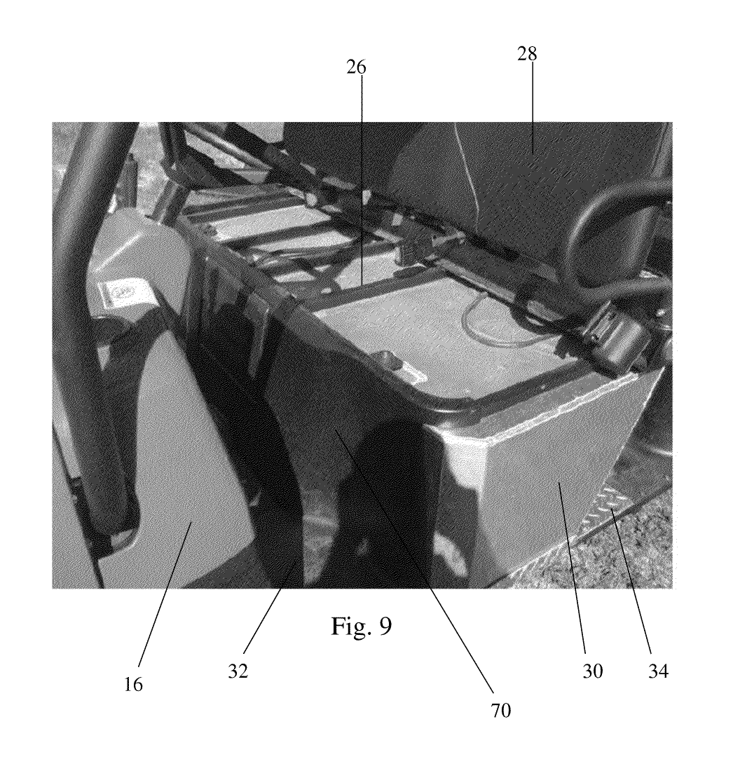

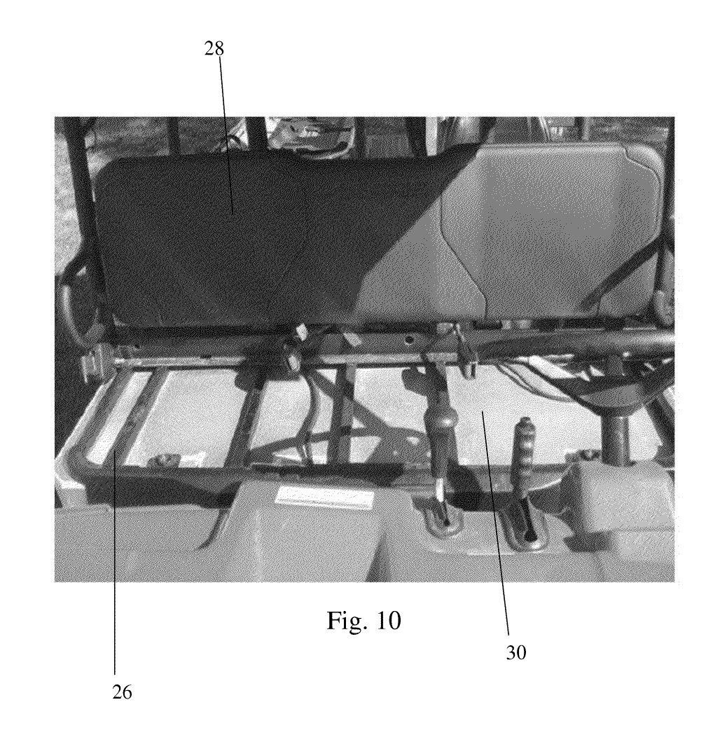

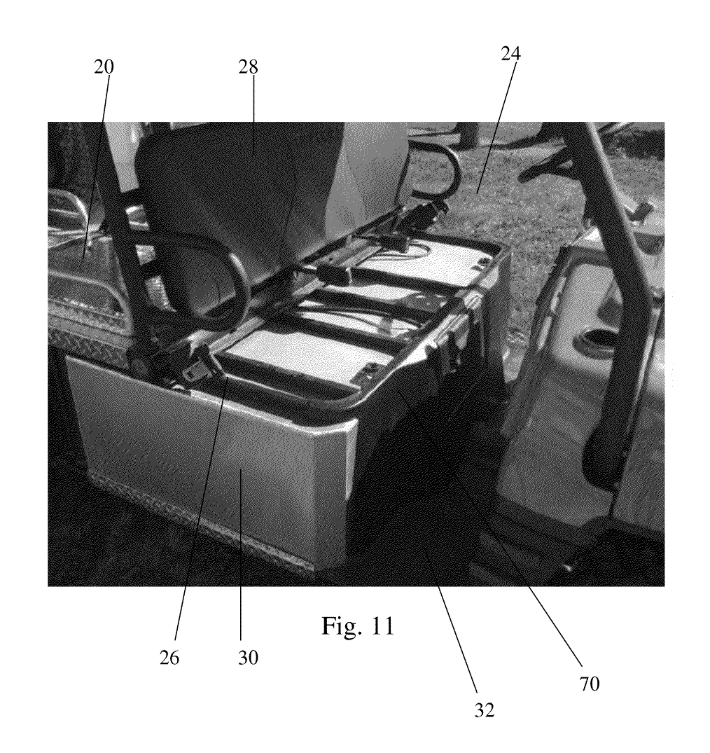

FIG. 9 is a front perspective view of tank 30 from the driver's side of UTV 10 with lower seat 29 removed. FIG. 10 is front elevation view of tank 30 for UTV 10 with lower seat 29 removed. FIG. 11 is a front perspective view of tank 30 from the passenger's side of UTV 10 with lower seat 29 removed. Tank 30 is located in cab 24 of UTV 10 under seat frame 26. In the prior art, seat frame 26 was placed on top of a plastic support system with a cavity under the driver's seat to store small equipment. In order to maximize the amount of liquid that could be carried on UTV 10, the prior plastic support system has been removed and replaced with tank 30. Tank 30 extends fully from the driver's side of UTV 10 to the passenger's side of UTV 10, as evident in FIG. 10. A part of the remaining plastic system can be seen as plastic front 70 in FIGS. 9 and 11. In the prior art, plastic front 70 wrapped around the edges of tank 30 and extended fully rearward. In order to maximize the span of tank 30 from the driver's side to the passenger's size, the edges and corners of plastic front 70 have been removed.

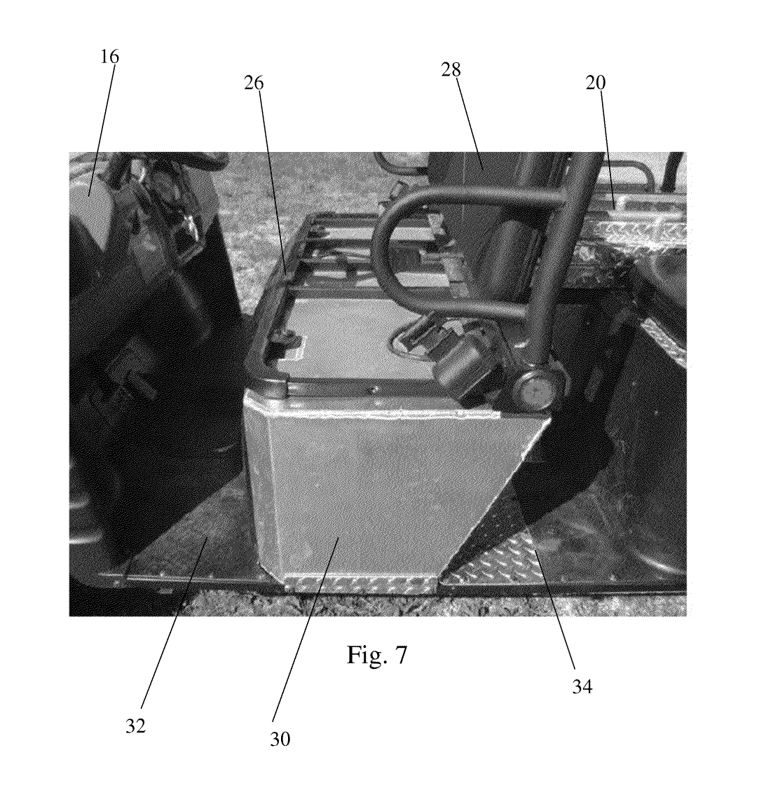

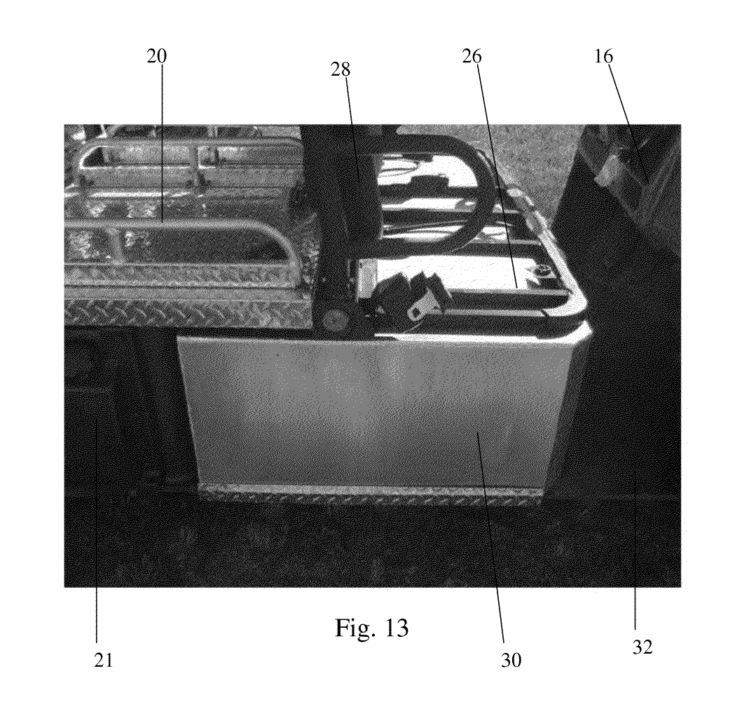

FIG. 7 is a perspective view of tank 30 beneath seat frame 26 of UTV 10. FIG. 13 is a passenger side elevation view of fuel tank 21 and tank 30 for UTV 10. Tank 30 extends fully from the driver's side to the passenger's side of UTV 10. As seen in FIG. 7, tank 30 extends rearward of the driver's seat to the second passenger's seat and rear footrest 34. As seen in FIG. 13, tank 30 extends rearward of the passenger's seat underneath flatbed 20. In the prior art, a third passenger's seat was provided in place of flat bed 20 on top of gas tank 21. Flatbed 20 has been extended forward over gas tank 21 here so a stretcher can be placed on flatbed 20. The stretcher will extend forward behind the first passenger's seat so that a passenger riding in the second passenger's seat can attend to a patient on the stretcher while UTV 10 is in operation. Further, removing the third passenger's seat allowed for tank 30 to extend further behind the first passenger's seat toward gas tank 21. This further maximized the amount of liquid that can be carried in tank 30.

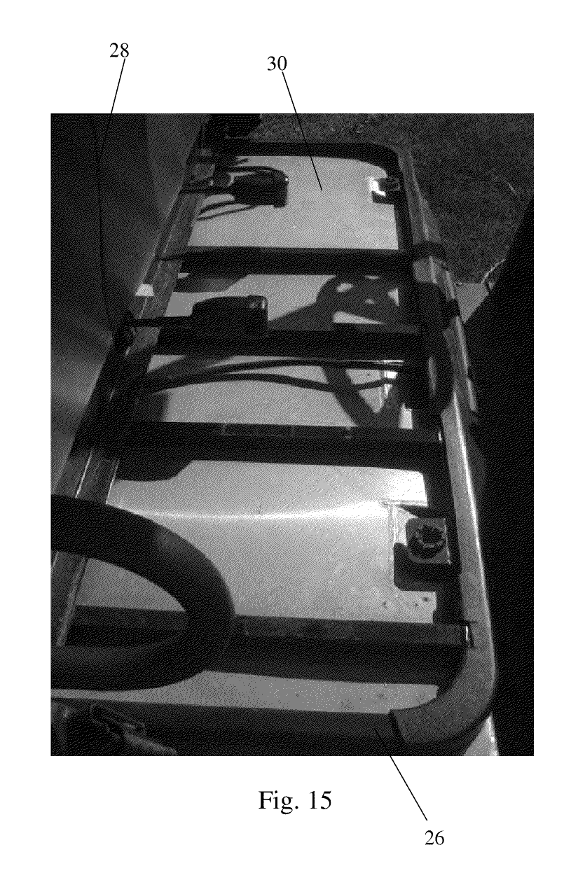

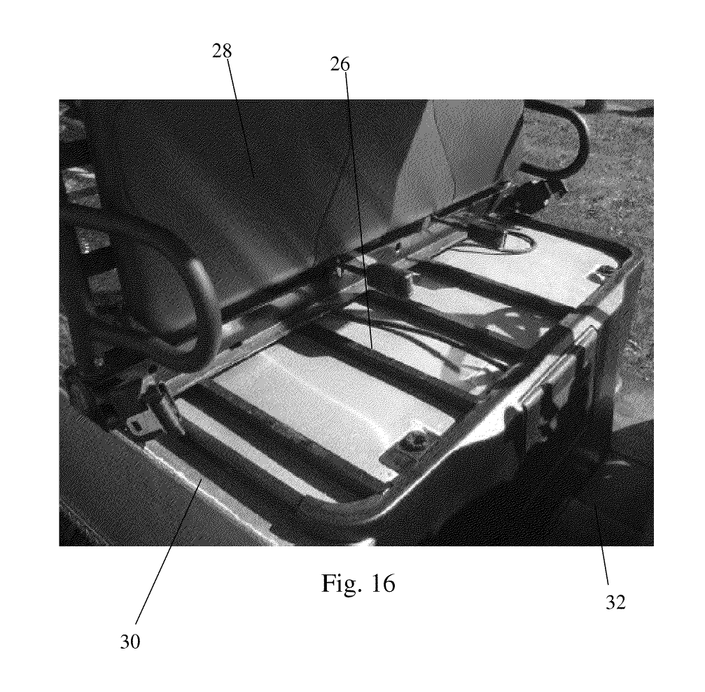

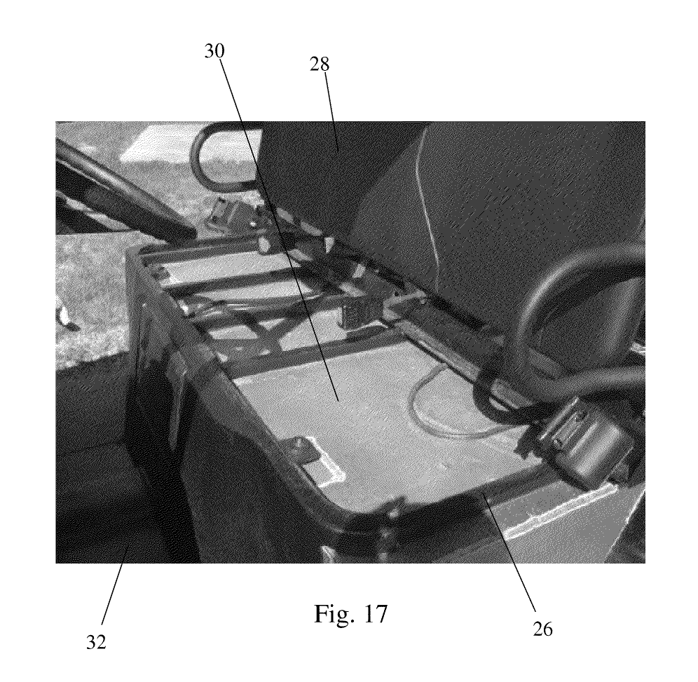

FIG. 17 is a driver's side perspective view of tank 30 beneath seat frame 26. FIG. 16 is a passenger's side perspective view of tank 30 beneath seat frame 26. FIG. 15 is a top plan view of tank 30 beneath seat frame 26. Seat frame 26 is bolted to tank 30 in the embodiment shown, although other means of attaching the two can be used including any type of fastener. As stated previously, in the prior art seat frame 26 was attached to a plastic support system. In the present invention, seat frame 26 has been modified to attach to tank 30. These modifications include adjusting the attachment means on seat frame 26 to fit with tank 30, and removing the two side portions of plastic front 70 so that the space under seat frame 26 can be optimized.

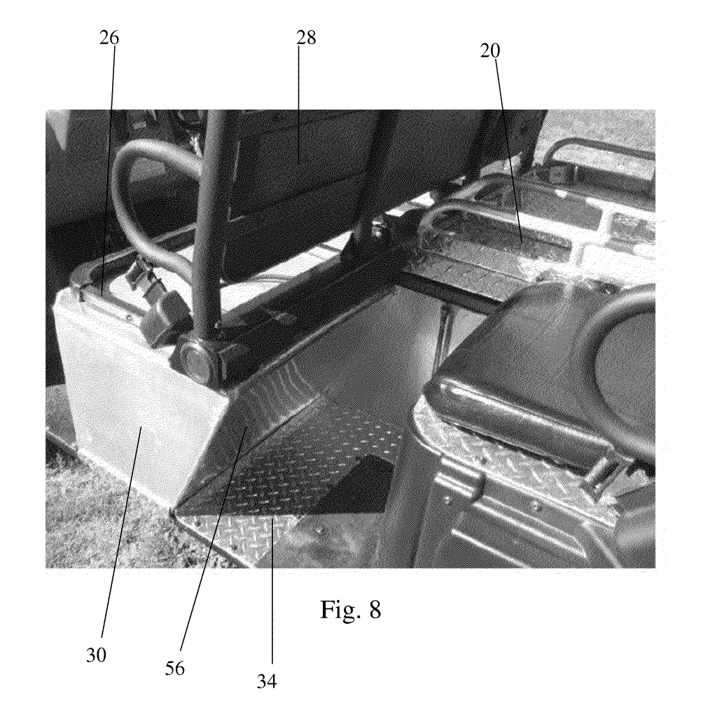

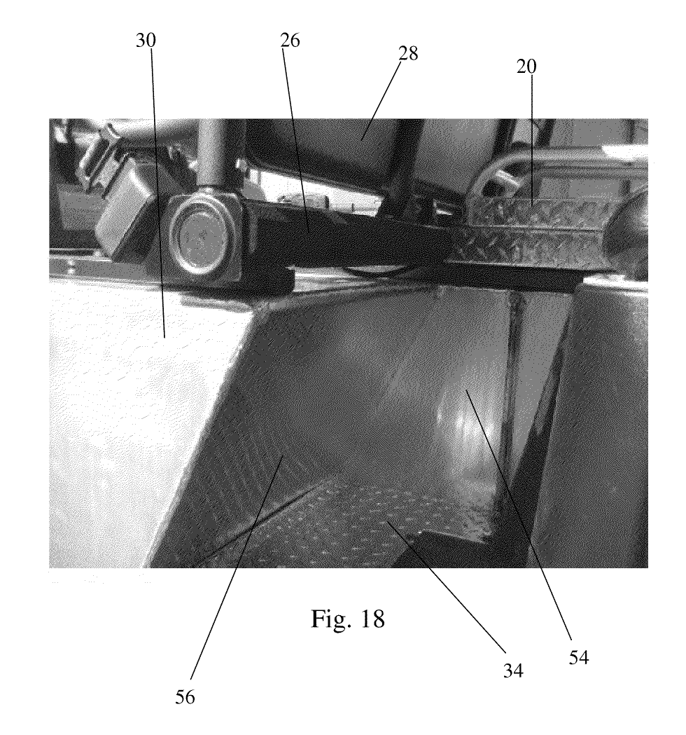

FIG. 8 is a rear perspective view of tank 30 from the driver's side of UTV 10 with lower seat 29 removed. FIG. 18 is a perspective view of tank 30 and a rear passenger seating area. On the first passenger's side, tank 30 extends rearward underneath flatbed 20. On the driver's side, tank 30 extends rearward until slanted aft end 56. Slanted aft end 56 mimics the shape of the prior plastic support system under seat frame 26. Slanted aft end 56 and rear footrest 34 are designed to provide leg and foot space for a second passenger. The design of slanted aft end 56 also allows tank 30 to extend fully rearward under the driver's seat to support seat frame 26, which again allows the capacity of tank 30 to be maximized. Leaving space for the second passenger's seat also allows a passenger riding on the second passenger's seat to tend to a patient on a stretcher on flatbed 20, as flatbed 20 extends forward next to the second passenger's seat.

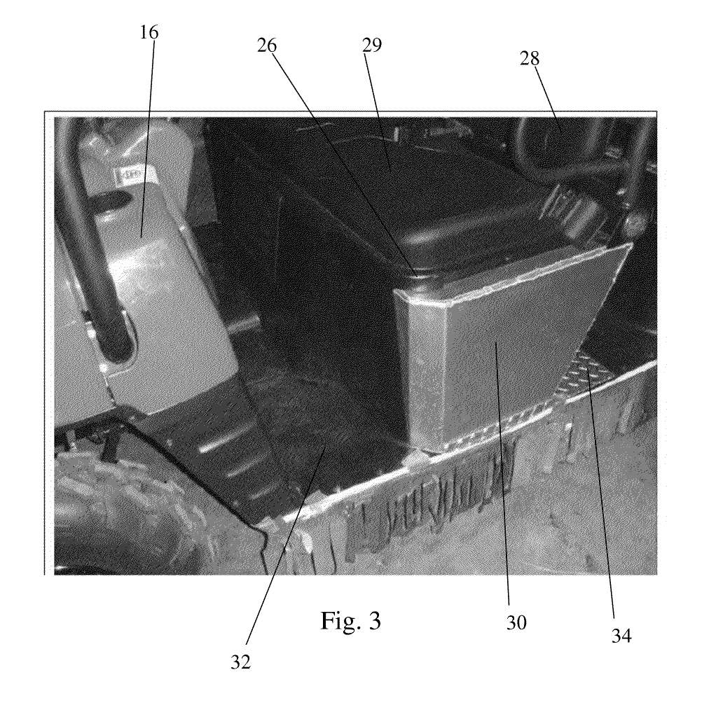

FIG. 3 is a front perspective view of tank 30 from the driver's side of UTV 10.

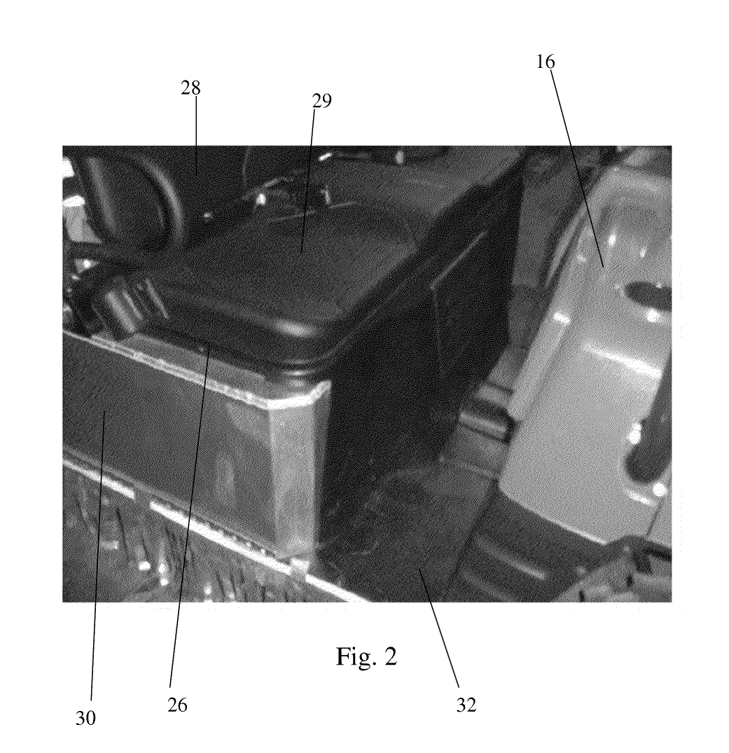

FIG. 2 is a perspective view of tank 30 from the passenger's side of UTV 10. FIG. 3 and FIG. 2 show tank 30 extending fully across UTV 10 from the driver's side to the passenger's side when lower seat 29 is attached to seat frame 26. As evident, the location and arrangement of tank 30 allows leg and foot space for the driver and first passenger, similar to the prior art, while maximizing the capacity of tank 30.

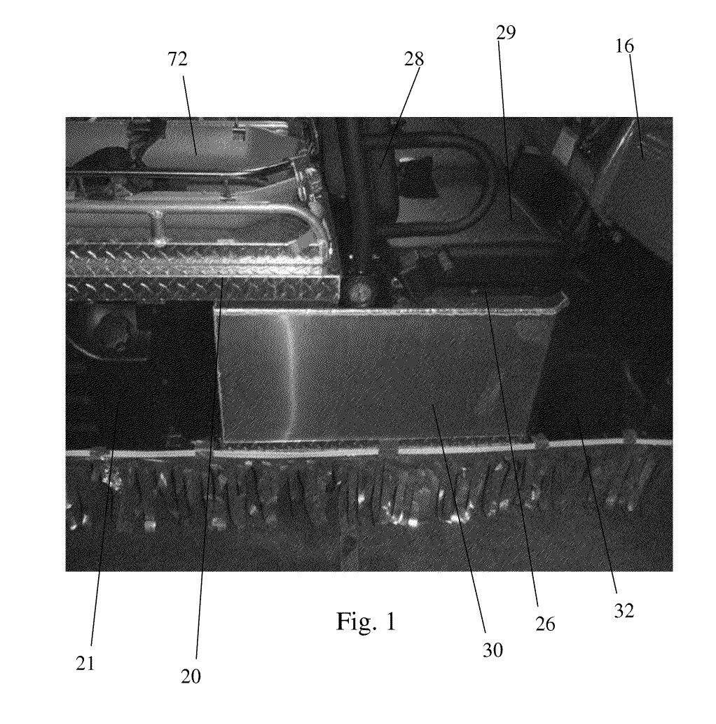

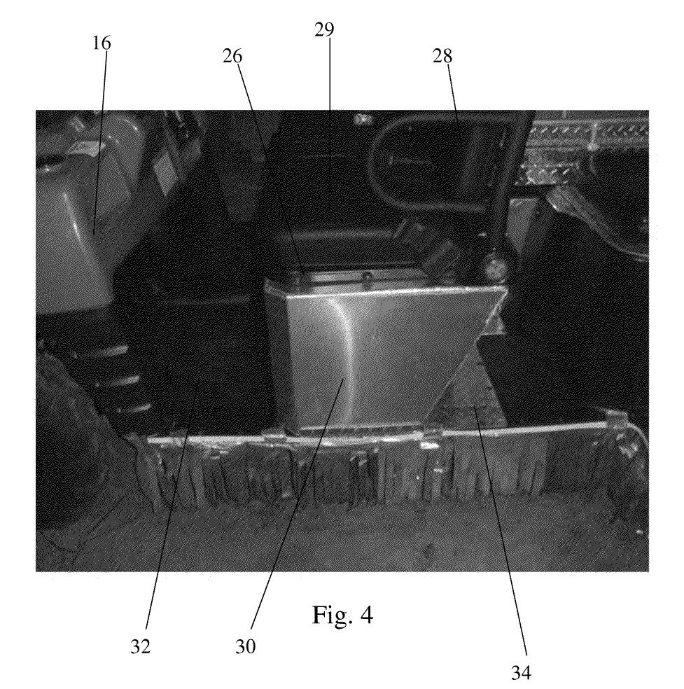

FIG. 4 is a side elevation view of tank 30. FIG. 1 is a side elevation view of tank 30 for UTV 10. FIG. 4 and FIG. 1 show how tank 30 extends rearward of the driver's seat to the second passenger's seat and rearward of the first passenger's seat underneath flatbed 20 to gas tank 21 with lower seat 29 attached to seat frame 26. As discussed above, this arrangement maximizes the capacity of tank 30. FIG. 1 also shows stretcher 72 on flatbed 20. Stretcher 72 is located beside the second passenger's seat, so that a passenger riding on the second passenger's seat can tend to a patient while UTV 10 is in operation.

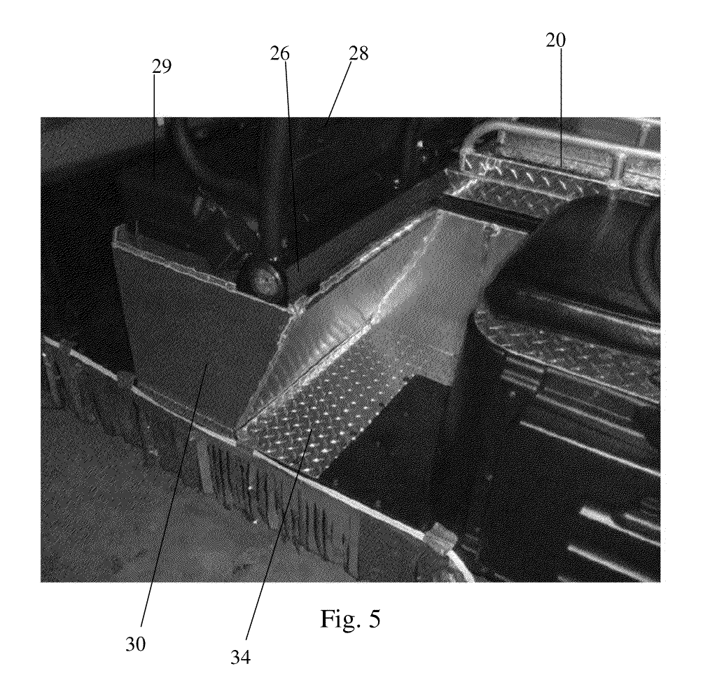

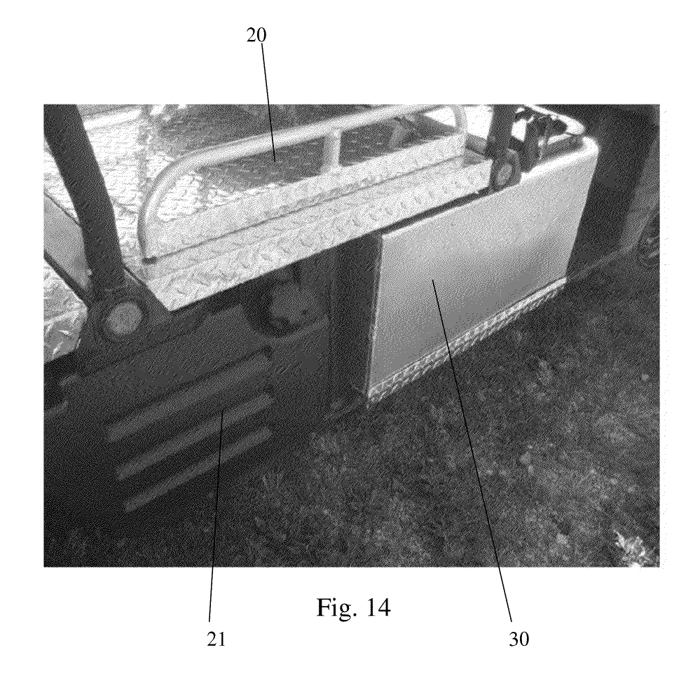

FIG. 5 is a rear perspective view of tank 30 from the driver's side of UTV 10. FIG. 5 shows the leg and foot room that is maintained for the second passenger's seat, while at the same time maximizing the capacity of tank 30. FIG. 14 is a side elevation view of tank 30 and gas tank 21. FIG. 14 shows how tank 30 extends rearward of the first passenger's seat to gas tank 21 underneath flatbed 20.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A utility terrain vehicle having a support frame capable of supporting a large liquid storage tank, wherein the utility terrain vehicle comprises:
four or more wheels;
a frame held above the ground by the wheels; and
a liquid storage tank; and
wherein the liquid storage tank is attached to the frame and creates a center of gravity for the utility terrain vehicle that is below the top of the liquid storage tank.

2. The utility terrain vehicle of claim 1, wherein the liquid storage tank is capable of holding over 100 gallons of liquid.

3. The utility terrain vehicle of claim 1, wherein the frame is reinforced with a subframe.

4. The utility terrain vehicle of claim 1, wherein the liquid storage tank is made out of a rigid and non-corrosive material.

5. The utility terrain vehicle of claim 1, wherein an inlet to the liquid storage tank has a volume large enough to create a pressure head over the liquid storage tank.

6. The utility terrain vehicle of claim 1, wherein a pump is connected to the liquid storage tank for moving liquid out of the liquid storage tank.

7. A utility terrain vehicle having a large liquid storage capacity, wherein the utility terrain vehicle comprises:
two front tires and two rear tires;
a vehicle frame held above the ground by the front tires and the rear tires;
one or more seats, wherein the seats have a seat frame, a lower seating surface, and an upper seating surface; and
a liquid storage tank; and
wherein the liquid storage tank is located above the vehicle frame and below the seat frame.

8. The utility terrain vehicle of claim 7, wherein the liquid storage tank supports the seat frame, lower seating surface, and upper seating surface.

9. The utility terrain vehicle of claim 7, wherein the liquid storage tank is capable of holding over 100 gallons.

10. The utility terrain vehicle of claim 7, wherein the liquid storage tank is made out of a rigid material with a high tensile strength to support large weights.

11. The utility terrain vehicle of claim 7, wherein the location of the liquid storage tank under the seat frame creates a low center of gravity for the utility terrain vehicle.

12. The utility terrain vehicle of claim 7, wherein an inlet to the liquid storage tank has a volume large enough to create a pressure head over the liquid storage tank.

13. The utility terrain vehicle of claim 7, wherein a pump is connected to the liquid storage tank for moving liquid out of the liquid storage tank.

14. A utility terrain vehicle having a large liquid storage capacity, wherein the utility terrain vehicle comprises:
two front tires and two rear tires;
a vehicle frame held above the ground by the front tires and the rear tires;
a subframe attached to the vehicle frame;
a first seat and a second seat, wherein the first and second seats have a combined seat frame, a lower seating surface, and an upper seating surface;
a flatbed;
a pump carried on the flatbed;
a liquid storage tank; and
an inlet to the liquid storage tank; and
wherein the liquid storage tank is located above the vehicle frame and below the lower seating surface; and
wherein the subframe provides addition support to the utility terrain vehicle.

15. The utility terrain vehicle of claim 14, wherein the liquid storage tank is capable of holding over 100 gallons.

16. The utility terrain vehicle of claim 14, wherein the inlet to the liquid storage tank is connected to the liquid storage tank with a hose and has a volume large enough to create a pressure head over the liquid storage tank.

17. The utility terrain vehicle of claim 14, wherein the pump is connected to the liquid storage tank with a hose.

18. The utility terrain vehicle of claim 14, wherein the hoses are attached to the subframe with a protector plate.

19. The utility terrain vehicle of claim 14, wherein the liquid storage tank extends rearward of the passenger seat under the flatbed.

20. The utility terrain vehicle of claim 14, wherein the flatbed is capable of holding a stretcher.
